(19) United States
(12) Patent Application Publication
(10) Pub. No.: US 2007/0024532 A1
(43) Pub. Date: Feb. 1, 2007

(54) Plasma display and driving method thereof

(76) Inventor: Seung-Hun Chae, Chunan-si (KR)

Correspondence Address: CHRISTIE, PARKER & HALE, LLP, PO BOX 7068, PASADENA, CA, 91109-7068, US

(21) Appl. No.: 11/489,130

(22) Filed: Jul. 18, 2006

(30) Foreign Application Priority Data
Jul. 27, 2005 (KR) 10-2005-0068333

(51) Int. Cl. G09G 3/28

(52) U.S. Cl. 345/63

(57) ABSTRACT

In a plasma display device, sustain electrodes and subfields forming one frame are divided into a plurality of groups including first and second groups. In a first subfield of the first group, discharge cells of a second group are initialized during a second reset period and address discharged during a second address period after discharge cells of a first group are initialized during a first reset period and address discharged during a first address period. A difference between voltages applied to the first and second electrodes of a turn-on discharge cell during the first or the second address period subsequent to an auxiliary reset period is set to be greater than a difference between voltages applied to the first and second electrodes of the turn-on discharge cell during the first or the second address period subsequent to a main reset period.

### CROSS-REFERENCE TO RELATED APPLICATION

This application claims priority to and the benefit of Korean Patent Application No. 10-2005-0068333 filed in the Korean Intellectual Property Office on Jul. 27, 2005, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display that uses plasma generated by a gas discharge process to display characters or images. It includes a plurality of discharge cells arranged in a matrix pattern.

One frame of the plasma display device is divided into a plurality of subfields each having a corresponding weight. Each subfield includes a reset period, an address period, and a sustain period. The reset period is for initializing the status of each discharge cell so as to facilitate an addressing operation on the discharge cell. The address period is for selecting turn-on/turn-off cells (i.e., cells to be turned on or off). In addition, the sustain period is for causing the cells to either continue discharge for displaying an image on the addressed cells or remain inactive.

FIG. 1 shows a driving waveform diagram of a conventional plasma display device. During the address period, a voltage VscL is sequentially applied to scan electrodes Y, and a turn-on discharge cell is selected by applying an address voltage Va to an address electrode A passing through the turn-on discharge cell to be selected among discharge cells formed by the scan electrodes to which the voltage VscL is applied. However, because an address operation is sequentially performed in all the discharge cells during the address period, an address discharge may not be appropriately generated due to a lack of priming particles in the discharge cells that are being addressed.

### SUMMARY OF THE INVENTION

The present invention provides a plasma display device for stably performing an address discharge and a driving method thereof.

An exemplary driving method according to an embodiment of the present invention drives a plasma display device by a plurality of subfields divided from a frame, the plasma display device having a plurality of first electrodes, a plurality of second electrodes, and a plurality of third electrodes crossing over or under the first and second electrodes. In the exemplary driving method, the plurality of first electrodes are divided into a plurality of groups having first and second groups, and the plurality of subfields are divided into a plurality of groups having first and second groups. In addition, in a subfield of the first group, first group discharge cells are initialized during a first reset period, a turn-on discharge cell is selected among the first group discharge cells during a first address period, second group discharge cells are initialized during a second reset period, a turn-on discharge cell is selected among the second group discharge cells during a second address period, and the selected first and second group discharge cells are sustain-discharged during a sustain period. In addition, a voltage difference between voltages respectively applied to the first and second electrodes of the turn-on discharge cell during the first address period is different from another voltage difference between voltages respectively applied to the first and second electrodes of the turn-on discharge cell during the second address period.

One of the first and second reset periods is an auxiliary reset period for gradually decreasing a voltage at the second electrode from a first voltage to a second voltage, and the other of the first and second reset periods is a main reset period for gradually decreasing the voltage at the second electrode from a fifth voltage to a sixth voltage after decreasing the voltage at the second electrode from a third voltage to a fourth voltage.

In addition, an eighth voltage is applied to the second electrode of the turn-on discharge cell during the first and second address periods while the first electrode is maintained at a seventh voltage, and a voltage difference between the seventh and eighth voltages during the first or the second address period subsequent to the auxiliary reset period is greater than a voltage difference between the seventh and eighth voltages during the first or the second address period subsequent to the main reset period. The first reset period is the auxiliary reset period and the second reset period is the main reset period. The seventh voltage during the first address period is higher than the seventh voltage during the second address period. The eighth voltage during the first address period is higher than the eighth voltage during the second address period.

In addition, in a subfield of the second group, the second group discharge cells are initialized during a third reset period, a turn-on discharge cell is selected among the second group discharge cells during a third address period, the first group discharge cells are initialized during a fourth reset period, a turn-on discharge cell is selected among the first group discharge cells during a fourth address period, and the selected first and second group discharge cells are sustain-discharged during a sustain period. A voltage difference between voltages respectively applied to the first and second electrodes of the turn-on discharge cell during the third address period is different from a voltage difference between voltages respectively applied to the first and second electrodes of the turn-on discharge cell during the fourth address period.

An exemplary plasma display device according to another embodiment of the present invention includes a plasma display panel, a controller, and a driving circuit. The plasma display panel includes a plurality of first electrodes, a plurality of second electrodes, and a plurality of third electrodes crossing the first and second electrodes. The controller divides the plurality of first electrodes into a plurality of groups having first and second groups, and divides one frame into a plurality of subfields having first and second groups. The driving circuit, in a subfield of the first group, initializes first group discharge cells during a first reset period, address discharges the first group discharge cells during a first address period, initializes second group discharge cells during a second reset period, and address discharges the second group discharge cells during a second address period.

In addition, the driving circuit applies voltages to the first and second electrodes of the turn-on discharge cell during the first and second periods so that a voltage difference between the voltages respectively applied to the first and second electrodes of the turn-on discharge cell during the first address period may be different from a voltage difference between the voltages respectively applied to the first and second electrodes of the turn-on discharge cell during the second address period.

### BRIEF DESCRIPTION OF THE DRAWINGS

FIG. 1 shows a driving waveform diagram of a conventional plasma display device.

FIG. 2 shows a diagram representing a plasma display device according to an exemplary embodiment of the present invention.

FIG. 3 to FIG. 6 respectively show diagrams representing driving waveforms of the plasma display device according to first to fourth exemplary embodiments of the present invention.

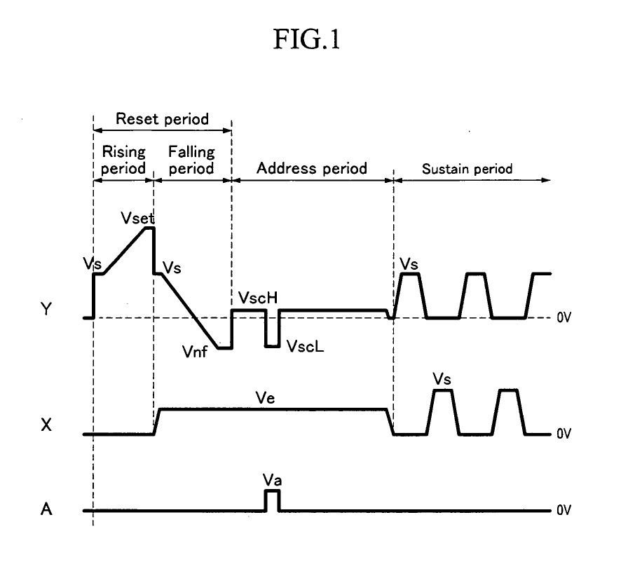

### DETAILED DESCRIPTION OF THE EMBODIMENTS

Wall charges mentioned in the following description mean charges formed and accumulated on a wall (e.g., a dielectric layer) close to an electrode of a discharge cell. The wall charge will be described as being “formed” or “accumulated” on the electrode, although the wall charges do not actually touch the electrodes. Further, a wall voltage means a potential difference formed on the wall of the discharge cell by the wall charge.

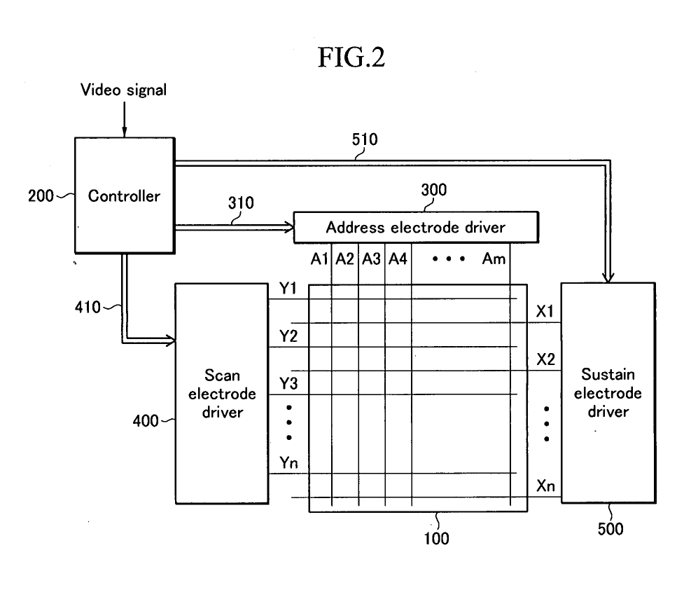

FIG. 2 shows a diagram representing the plasma display device according to an exemplary embodiment of the present invention. The plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain and scan electrodes X1 to Xn and Y1 to Yn extending in a row direction. The sustain and scan electrodes form pairs. The sustain electrodes X1 to Xn are formed respectively corresponding to the scan electrodes Y1 to Yn, and ends of the sustain electrodes X1 to Xn are connected in common. In addition, the PDP 100 includes a substrate (not shown) having the sustain and scan electrodes X1 to Xn and Y1 to Yn, and another substrate having the address electrodes A1 to Am. The two substrates are arranged to face each other with a discharge space between them so that a common direction of the scan electrodes Y1 to Yn and the sustain electrodes X1 to Xn may cross a direction of the address electrodes A1 to Am. A discharge space formed at an area where the address electrodes A1 to Am cross over the sustain and scan electrodes X1 to Xn and Y1 to Yn forms a discharge cell. The sustain, scan, and address electrodes may be referred to as X, Y, and A electrodes, respectively. The PDP 100 shows one exemplary embodiment, and other equivalent panels to which subsequent driving waveforms are applicable can be included in the present invention.

The controller 200 receives an external video signal and outputs an address electrode driving control signal 310, a sustain electrode driving control signal 510, and a scan electrode driving control signal 410. In addition, the controller 200 divides a frame into a plurality of subfields, divides the plurality of sustain electrodes X into a plurality of groups, and drives them. Time duration of each subfield includes a reset period, an address period, and a sustain period.

After receiving the address electrode driving control signal 310 from the controller 200, the address electrode driver 300 applies a display data signal for selecting discharge cells to be displayed to the address electrodes A1 to Am.

The scan electrode driver 400 applies a driving voltage to the scan electrodes Y after receiving the scan electrode driving control signal 410 from the controller 200. Similarly, the sustain electrode driver 500 applies a driving voltage to the sustain electrodes X after receiving the sustain electrode driving control signal 510 from the controller 200.

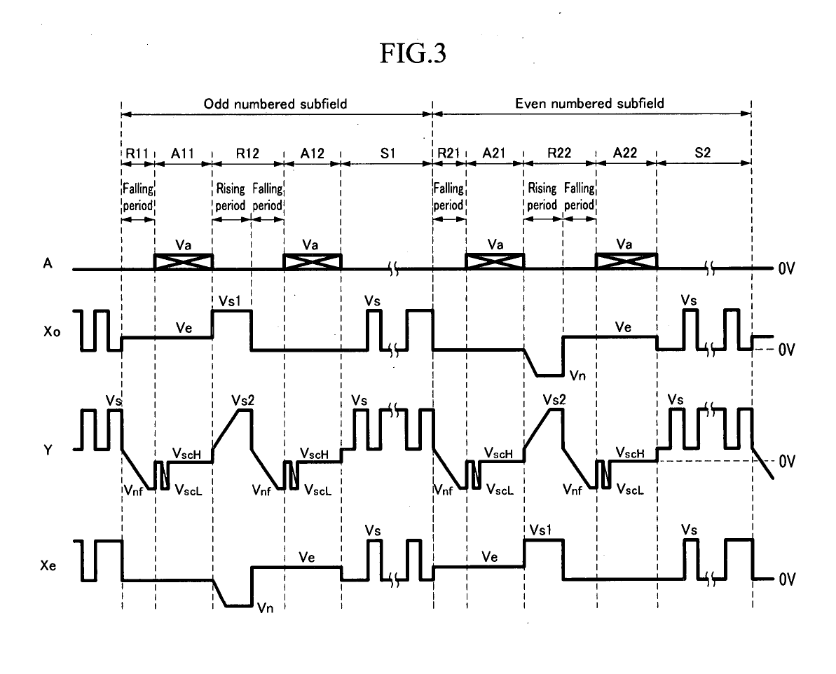

Driving waveforms according to a first exemplary embodiment of the present invention for the plasma display device of FIG. 2 will be described with reference to FIG. 3. For convenience of descriptions, a driving waveform applied to the scan, sustain, and address electrodes, Y, X, A forming one cell will be described.

FIG. 3 shows a diagram representing the first exemplary embodiment of the driving waveforms of the plasma display device according to embodiments of the present invention.

The plasma display device driving waveform according to the first exemplary embodiment of the present invention divides the plurality of X electrodes into groups of X electrodes. In FIG. 3, the plurality of X electrodes X1 to Xn are divided into two groups, a first group Xo includes odd-numbered X electrodes, and a second group Xe includes even-numbered X electrodes. Hereinafter, discharge cells formed by the Y electrodes and A electrodes and X electrodes of the first group Xo will be referred to as odd or first group discharge cells, and discharge cells formed by the Y electrodes and A electrodes and X electrodes of the second group Xe will be referred to as even or second group discharge cells.

As shown in FIG. 3, during one subfield, the address discharge is performed for the first group discharge cells Xo after an auxiliary reset is performed, and the address discharge is performed for the second group discharge cells Xe after a main reset is performed. And during other subfield, the address discharge is performed for the the second group discharge cell Xe after an auxiliary reset is performed, and the address discharge is performed for the first group discharge Xo after a main reset is performed. The auxiliary reset is a reset operation performed during a reset period including only a falling period, and the main reset is a reset operation performed during a reset period including a rising period and a falling period. The auxiliary reset is to initialize the discharge cells on which the sustain discharge has been generated during a previous subfield. And during the one subfield, the main reset is to initialize the discharge cells of the second group, and during the other subfield, the main reset is to initialize the discharge cells of the first group.

As described, the address operation is performed for the second group discharge cells Xe reset by the main reset after the address operation is performed for the first group discharge cells Xo reset by the auxiliary reset. Therefore, a time for performing the address operation from a first discharge cell to the last discharge cell after the reset operation is performed may be reduced by half compared to a conventional driving method in which the address operation is sequentially performed for the discharge cells after the reset operation. Accordingly, the address discharge may be stably generated.

While in FIG. 3 the auxiliary reset is performed before the main reset, the reset operation may be differently performed. For example, the main reset may be performed before the auxiliary reset, or only one of the auxiliary and main resets may be performed. As described above, the auxiliary reset causes a reset discharge when the sustain discharge is generated in the previous subfield but does not cause the reset discharge when the sustain discharge is not generated in the previous subfield. Therefore, a time interval between an end of the sustain discharge in the previous subfield and a beginning of the auxiliary reset may be increased when the auxiliary reset is performed after the main reset. In this case, the auxiliary reset may inappropriately generate wall charges because priming particles may be eliminated, and a time for performing the reset operation may be increased when only the main reset is performed. Therefore, according to the first exemplary embodiment of the present invention, the auxiliary reset is performed before the main reset in each of the subfields.

First, the driving waveform applied to the electrodes X, Y, A during an odd-numbered subfield will be described.

As shown in FIG. 3, during the odd numbered subfield, a last sustain discharge is generated between the Y electrode and the X electrode of the first group Xo when a voltage Vs is applied to the Y electrode and a reference voltage (0V in FIG. 3) is applied to the X electrode Xo during the sustain period. With the voltages shown, the sustain discharge is not generated between the Y electrode and the X electrode of the second group Xe because the X electrode of the second group Xe is also biased at the voltage Vs. The last sustain discharge may be generated between the Y electrode and the X electrode of the second group Xe when the voltage Vs is applied to the X electrode of the second group Xe if the reference voltage, and not Vs, is applied to the Y electrode.

For a falling period of a reset period R11, a voltage at the Y electrode is gradually decreased to a voltage Vnf from the last sustain pulse Vs applied to the Y electrode during the sustain period of the previous subfield. At this time, the reference voltage is being applied to the X electrode of the second group Xe, and the X electrode of the first group Xo is biased at a voltage Ve. Then, because while the voltage at the Y electrode is being decreased, a weak reset discharge is generated between the Y electrode and the X electrode of the first group Xo and between the Y electrode and the A electrode, negative (−) wall charges formed on the Y electrode and positive (+) wall charges formed on the X electrode of the first group Xo and the A electrode are eliminated.

Accordingly, as shown in FIG. 3, because a weak discharge is generated when the voltage level at an electrode is gradually changed, wall charges are formed so that a sum of an external voltage and a wall voltage of a cell may be maintained at a discharge firing voltage state.

Typically, a voltage of (Ve-Vnf) is set close to a discharge firing voltage between the Y and X electrodes. Then, during the sustain period, a misfiring may be prevented in a cell where the address discharge was not generated during the address period because a wall voltage between the Y and X electrodes reaches 0V.

In addition, negative (−) wall charges are formed on the X electrode of the second group Xe and positive (+) wall charges are formed on the Y electrode after the last sustain discharge, and a potential difference between the Y electrode and the X electrode of the second group Xe is reduced when the voltage at the Y electrode is decreased to the voltage Vnf. Accordingly, the reset discharge is not generated between the Y electrode and the X electrode of the second group Xe during the reset period R11.

Subsequently, to select a discharge cell during an address period A11, a scan pulse having the voltage VscL is sequentially applied to the Y electrodes, and the Y electrodes to which the voltage VscL is not applied are biased at a voltage VscH. In addition, an address pulse having a voltage Va is applied to an A electrode passing through the discharge cell to be selected among the plurality of discharge cells formed by the Y electrodes to which the voltage VscL is applied. The A electrodes, corresponding to the discharge cells which are not selected, are biased at the reference voltage. The voltage VscL is referred to as a scan voltage, and the voltage VscH is referred to as a non-scan voltage.

Then, positive (+) wall charges are formed on the Y electrode and negative (−) wall charges are formed on the X electrode of the first group Xo because an address discharge is generated in the discharge cell formed by the A electrode receiving the voltage Va and the Y electrode receiving the voltage VscL. In addition, negative (−) wall charges are formed on the A electrode.

In this case, the address discharge is not generated in the second group discharge cells during the address period A11 because positive (+) wall charges are formed on the Y electrodes.

In FIG. 3 the voltage Ve is applied to the X electrode of the first group Xo during the falling period of the reset period R11 and during the address period A11. However during the same periods, alternatively, the reference voltage equal to the voltage applied to the X electrode of the second group Xe may be applied to the X electrode of the first group Xo.

Accordingly, the reset discharge is performed for the second group discharge cells after the address discharge is finished for the first group discharge cells.

During a rising period of a reset period R12, the voltage at the Y electrode is gradually increased from the reference voltage to a voltage Vs2 while the X electrode of the first group Xo and the A electrode are respectively maintained at a voltage Vs1 and the reference voltage. A voltage Vn which is a negative voltage is applied to the X electrode of the second group Xe. Then, negative (−) wall charges are formed on the Y electrode and positive (+) wall charges are formed on the X electrode of the second group Xe as a weak reset discharge is generated between the Y electrode and the X electrode of the second group Xe while the voltage at the Y electrode is being increased. Because it is required to initialize all the cells during the reset period R12, a difference between the voltage Vs1, applied to the first group Xo, and the voltage Vn, applied to the second group Xe, is high enough to generate discharges in their respective cells, each under their own respective conditions. For example, during the rising period of the reset period R12, the voltage Vs1 applied to the X electrodes of the first group Xo is high enough to prevent a reset discharge in these discharge cells while the voltage Vn applied to the X electrodes of the second group Xe is low enough to facilitate a reset discharge in the corresponding discharge cells.

When the voltages Vs1 and Vs2 are respectively set equal to a sustain discharge voltage Vs applied to the X and Y electrodes for generating the sustain discharge during the sustain period, the number of additional power sources may be reduced.

During a falling period of the reset period R12, the voltage at the Y electrode is gradually decreased from the reference voltage to the voltage Vnf while the X electrode of the first group Xo and the X electrode of the second group Xe are respectively maintained at the reference voltage and the voltage Ve. Then, the wall charges formed between the Y and X electrodes are eliminated as the weak reset discharge is generated between the Y electrode and the X electrode of the second group Xe while the voltage at the Y electrode is being decreased.

In addition, even during the falling period of the reset period R12, the reset discharge is not generated between the Y electrode and the X electrode of the first group Xo. The X electrode of the first group Xo is biased at the voltage Vs1 when the voltage at the Y electrode is increased to the voltage Vs2. Therefore, a wall charge state after the rising period is substantially equivalent to a wall charge state after the address period. Then, during the falling period of the reset period R12, the X electrode of the first group Xo is biased at the reference voltage when the voltage at the Y electrode is reduced to the voltage Vnf encouraging positive (+) wall charges to be formed on the Y electrode and negative (−) wall charges to be formed on the X electrode. In this case, the potential difference between the Y electrode and the X electrode of the first group Xo is reduced, and therefore the reset discharge is not generated between the Y electrode and the X electrode of the first group Xo.

Subsequently, during an address period A12, to select a discharge cell, the scan pulse having the voltage VscL is sequentially applied to the Y electrodes, and the Y electrodes to which the voltage VscL is not applied are biased at the voltage VscH. As mentioned above, the voltage VscL is referred to as a scan voltage, and the voltage VscH is referred to as a non-scan voltage. In addition, the address pulse having the voltage Va is applied to the A electrode passing through the discharge cell to be selected among the plurality of discharge cells formed by the Y electrodes to which the voltage VscL is applied, and the A electrodes which are not selected are biased at the reference voltage. Then, positive (+) wall charges are formed on the Y electrode and negative (−) wall charges are formed on the X electrode of the second group Xe as the address discharge is generated on the discharge cell formed by the Y electrode receiving the voltage VscL and the A electrode receiving the Voltage Va. In addition, negative (−) wall charges are formed on the A electrode.

Subsequently, a sustain pulse having the voltage Vs is sequentially applied to the Y electrodes and the X electrodes of the first and second groups Xo, Xe during a sustain period S1. Then, a discharge is generated on the Y and X electrodes by the voltage Vs and a wall voltage formed by the address discharge between the Y and X electrodes during the preceding address period. In addition, the voltage Vs is applied to the X electrode of the first group Xo, and the reference voltage is applied to the X electrode of the second group Xe when the last sustain pulse is applied to the Y electrode.

Driving waveforms applied during the even-numbered subfield will now be described.

As shown in FIG. 3, during the even-numbered subfield, the last sustain discharge is generated between the Y electrode and the X electrode of the second group Xe because the voltage Vs is applied to the Y electrode and the reference voltage is applied to the X electrode of the second group Xe during the a sustain period of a previous subfield, for example, during the sustain period S1 of the odd-numbered subfield. The sustain discharge is not generated between the Y electrode and the X electrode of the first group Xo because the X electrode of the first group Xo is also biased at the voltage Vs. Conversely, when the voltage Vs is applied to the X electrode of the first group Xo and the reference voltage is applied to the Y electrode, the last sustain discharge is generated between the X electrode of the first group Xo and the Y electrode.

During a falling period of a reset period R21, the voltage at the Y electrode is gradually decreased to the voltage Vnf while the last sustain pulse is applied to the Y electrode during the sustain period of the previous subfield. In this case, the reference voltage is applied to the A electrode and the X electrode of the first group Xo, and the X electrode of the second group Xe is biased at the voltage Ve. Then, the negative (−) wall charges formed on the Y electrode and the positive (+) wall charges formed on the A electrode and the X electrode of the second group Xe are eliminated as a weak discharge is generated between the Y electrode and the X electrode of the second group Xe while the voltage at the Y electrode is decreased. In this case, as described above, the reset discharge is not generated between the Y electrode and the X electrode of the first group Xo during the reset period because negative (−) wall charges are formed on the X electrode of the first group Xo and positive (+) wall charges are formed on the Y electrode after the last sustain discharge.

To select the discharge cell during an address period A21, the scan pulse having the voltage VscL is sequentially applied to the Y electrodes, and the Y electrodes to which the voltage VscL is not applied are biased at the voltage VscH. In addition, the address voltage Va is applied to the A electrode passing through the discharge cell to be selected among the plurality of the discharge cells formed by the Y electrodes to which the voltage VscL is applied, and the A electrodes which are not selected are biased at the reference voltage. Positive (+) wall charges are formed on the Y electrode and negative (−) wall charges are formed on the X electrode of the second group Xe as the address discharge is generated in the discharge cell formed by the A electrode receiving the voltage Va and the Y electrode receiving the voltage VscL. In addition, negative (−) wall charges are formed on the A electrode.

At this time, because positive (+) wall charges are formed on the Y electrode, a discharge is not generated in the first group discharge cells during the address period. Accordingly, the reset discharge is performed for the first group discharge cells after the address discharge operation is finished on the second group discharge cells.

During a rising period of a reset period R22, the voltage at the Y electrode is gradually increased from the reference voltage to the voltage Vs2 while the X electrode of the second group Xe and the A electrode are respectively maintained at the voltage Vs1 and the reference voltage. In this case, the voltage Vn which is a negative voltage is applied to the X electrode of the first group Xo. Then, negative (−) wall charges are formed on the Y electrode and positive (+) wall charges are formed on the X electrode of the second group Xe as a weak reset discharge is generated between the Y electrode and the X electrode of the first group Xo while the voltage at the Y electrode is increased.

In addition, during a falling period of the reset period R22, the voltage at the Y electrode is gradually decreased from the reference voltage to the voltage Vnf while the X electrodes of the first and second groups Xo, Xe are respectively maintained at the voltage Ve and the reference voltage. Then, the wall charges formed on the Y and X electrodes are eliminated as a weak discharge is generated between the Y electrode and the X electrode of the first group Xo while the voltage at the Y electrode is decreased.

In addition, the reset discharge is not generated between the Y electrode and the X electrode of the second group Xe during the reset period R22 as described above.

Subsequently, to select a discharge cell during an address period A22, the scan pulse having the voltage VscL is sequentially applied to the Y electrodes, and the Y electrodes to which the voltage VscL is not applied are biased at the voltage VscH. In addition, the address pulse having the voltage Va is applied to the A electrode passing through the discharge cell to be selected among the plurality of the discharge cells formed by the Y electrodes to which the voltage VscL is applied, and the A electrodes which are not selected are biased at the reference voltage. Then, positive (+) wall charges are formed on the Y electrode and negative (−) wall charges are formed on the X electrode of the first group Xo as the address discharge is generated in the discharge cell formed by the A electrode receiving the voltage Va and the Y electrode receiving the voltage VscL. In addition, negative (−) wall charges are formed on the A electrode.

Subsequently, during a sustain period S2, the sustain pulse having the voltage Vs is sequentially applied to the Y electrode and the X electrodes of the first and second groups Xo, Xe. Then, a discharge is generated by the voltage Vs and a wall voltage formed by the address discharge of the preceding address period, between the Y and X electrodes Xo, Xe.

Accordingly, in the first exemplary embodiment of the driving method of the present invention, an address discharge may be stably generated because the first group discharge cell is addressed after being initialized and the second group discharge cell is addressed after being initialized.

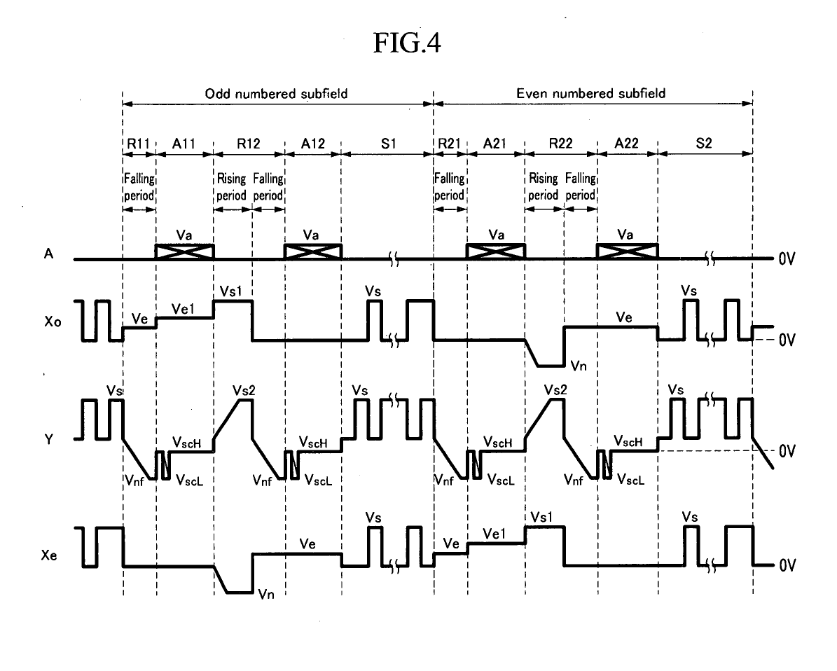

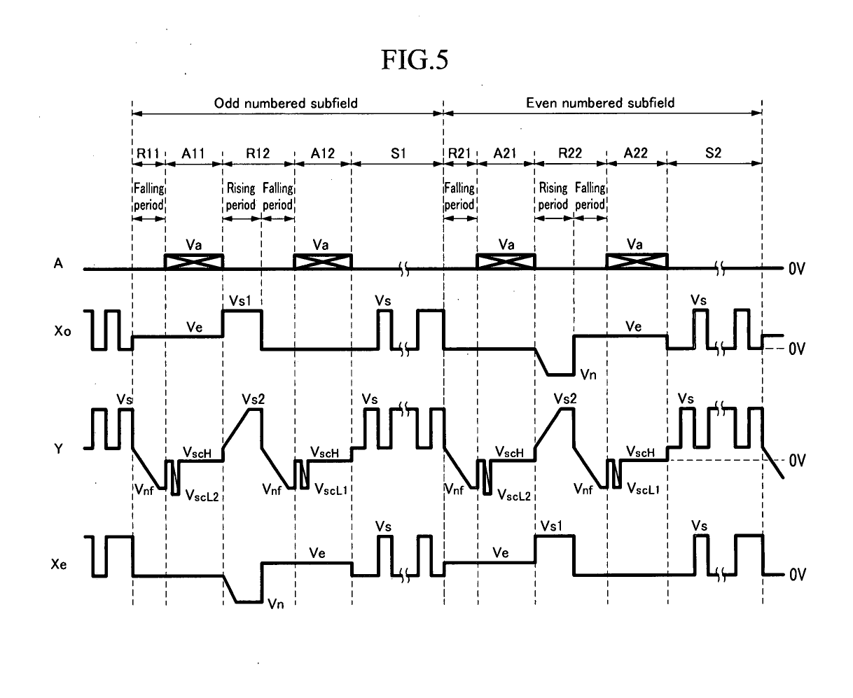

Priming particles are formed in a discharge space by the auxiliary reset R11, R21 to a lesser extent than priming particles formed by the main reset R12, R22, because the main reset is to initialize all the discharge cells and the auxiliary reset is to initialize the cells having experienced the sustain discharge in the previous subfield as described above. Consequently, the address discharge may not be generated after the auxiliary reset. Therefore, methods for appropriately generating the address discharge after the auxiliary reset according to other exemplary embodiments of the present invention will now be described with reference to FIG. 4 and FIG. 5.

FIG. 4 and FIG. 5 respectively show driving waveforms according to second and third exemplary embodiments of the present invention for driving the plasma display device of FIG. 2. In FIG. 5, a level of VscL1 is equal to a level of the voltage VscL shown in FIG. 3.

As shown in FIG. 4, in the odd-numbered subfield, a voltage Ve1 higher than the voltage Ve is applied to the X electrode of the first group Xo to generate the address discharge in the first group discharge cells during the address period A11 subsequent to the auxiliary reset R11.

Similarly, in the even-numbered subfield the voltage Ve1 higher than the voltage Ve is applied to the X electrode of the second group Xe to generate the address discharge in the second group discharge cells during the address period A21 subsequent to the auxiliary reset R21.

Accordingly, because a voltage difference between X and Y electrodes during the address period subsequent to the auxiliary reset becomes higher than a voltage difference between the X and Y electrodes during the address period subsequent to the main reset, the discharge may be stably generated when the auxiliary reset is performed.

In addition, as shown in FIG. 5, differing from the second exemplary embodiment of the present invention, a scan pulse having a voltage VscL2 lower than the voltage VscL1 may be applied to the Y electrode of the turn-on discharge cell during the address periods A11 and A21 subsequent to the auxiliary resets. Then, the address discharge may be stably generated when the auxiliary reset is performed because a difference between the voltage Va applied to the A electrode and the voltage VscL2 applied to the Y electrode during the address period subsequent to the auxiliary reset becomes greater than a difference between the voltages applied to these electrodes Va, VscL1 during the address period subsequent to the main reset.

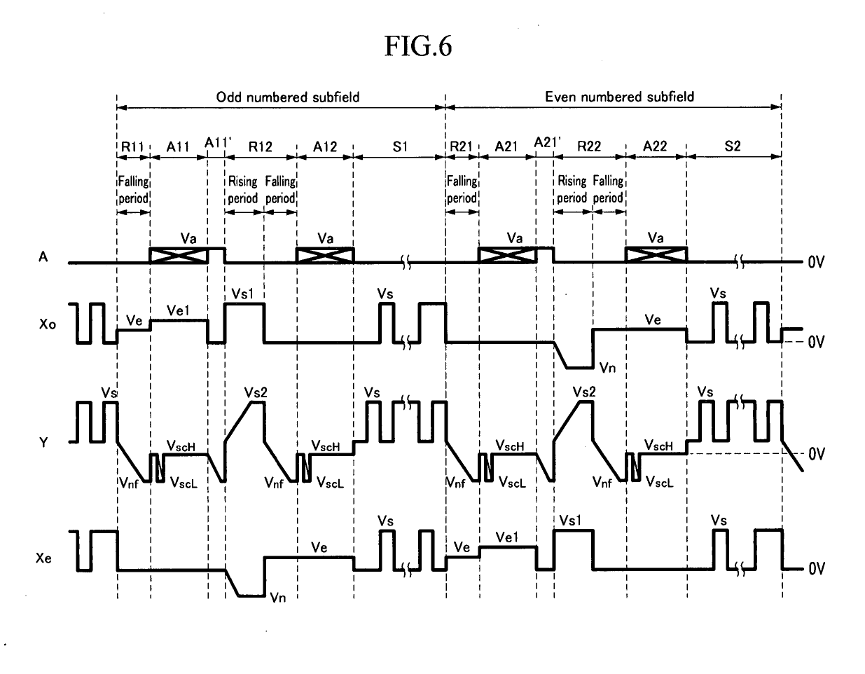

In the first to third exemplary embodiments of the present invention, the voltage at the Y electrode during the rising period of the main reset R12, R22 is close to the voltage Vs. In these embodiments, the voltage difference between the Y and X electrodes is increased because the voltage Vn lower than the reference voltage is applied to the X electrode, and therefore the wall charges are sufficiently formed between the Y and X electrodes. However, the wall charges may not be sufficiently formed between the Y and A electrodes because a voltage difference between the Y and A electrodes is not high enough to form the wall charges. Therefore, a subsequent discharge may not be appropriately generated. A method for sufficiently forming the wall charges between the Y and A electrodes according to a fourth exemplary embodiment of the present invention will now be described with reference to FIG. 6.

FIG. 6 shows a diagram representing driving waveforms according to the fourth exemplary embodiment of the present invention for the plasma display device of FIG. 2. The driving waveforms for the X and Y electrodes are similar to the waveforms shown in FIG. 4. The driving waveform for the A electrode is different.

As shown in FIG. 6, during periods A11′ and A21′ following the address periods A11 and A21, that are in turn subsequent to the reset periods R11 and R21 for performing the auxiliary reset, the voltage Va is applied to the A electrode. During the periods A11′ and A21′, the voltage at the Y electrode is gradually decreased from a voltage VscH to the voltage VscL while the X electrodes of the first and second groups Xo, Xe are biased at the reference voltage. Accordingly, negative (−) wall charges are formed on the A electrode and positive (+) wall charges are formed on the Y electrode. That is, a discharge is quickly generated between the Y and A electrodes during the rising period of the subsequent reset period R12, R22 because a potential caused by the wall charges of the Y electrode is increased higher than the potential caused by the wall charges of the A electrode. Therefore, the wall charges are sufficiently formed between the Y and A electrodes.

Voltage levels at the respective electrodes described in the first to fourth exemplary embodiments of the present invention may vary provided that voltage differences between the respective A, X, and Y electrodes are similar to those according to the exemplary embodiment of the present invention.

According to the exemplary embodiments of the present invention, stable address discharge may be generated because the first group discharge cell is addressed after being initialized and the second group discharge cell is addressed after being initialized. In this case, a more stable address discharge may be performed when the voltage difference between the sustain and scan electrodes of the turn-on discharge cell is increased during the address period subsequent to the auxiliary reset.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A driving method for driving a plasma display device by a plurality of subfields divided from a frame, the plasma display device having a plurality of first electrodes, a plurality of second electrodes, and a plurality of third electrodes crossing a direction of the first electrodes and the second electrodes, discharge cells being formed where the third electrodes cross over the first electrodes and the second electrodes, the plurality of first electrodes being divided into a plurality of groups including a first group of the first electrodes and a second group of the first electrodes, first group discharge cells corresponding to the first group of the first electrodes and second group discharge cells corresponding to the second group of first electrodes, the plurality of subfields being divided into a plurality of groups including a first subfield group and a second subfield group, the driving method comprising during a subfield of the first subfield group:
initializing the first group discharge cells during a first reset period;
selecting a turn-on discharge cell among the first group discharge cells during a first address period;
initializing the second group discharge cells during a second reset period;
selecting a turn-on discharge cell among the second group discharge cells during a second address period; and
sustain-discharging selected turn-on discharge cells during a sustain period,
wherein a voltage difference between the first electrode and the second electrode of a turn-on discharge cell selected during the first address period is different from a voltage difference between the first electrode and the second electrode of a turn-on discharge cell selected during the second address period.

2. The driving method of claim 1, wherein either the first reset period or the second reset period is an auxiliary reset period for gradually decreasing a voltage at the second electrode from a first voltage to a second voltage, and the other of the first reset period and the second reset period is a main reset period for gradually increasing the voltage at the second electrode from a third voltage to a fourth voltage followed by gradually decreasing the voltage at the second electrode from a fifth voltage to a sixth voltage.

3. The driving method of claim 2,
wherein during the first address period the first electrode of the turn-on discharge cell of the first group discharge cells is maintained at a seventh voltage while an eighth voltage is applied to the second electrode of the turn-on discharge cell of the first group discharge cells,
wherein during the second address period the first electrode of the turn-on discharge cell of the second group discharge cells is maintained at the seventh voltage while the eighth voltage is applied to the second electrode of the turn-on discharge cell of the second group discharge cells, and
wherein a difference between the seventh voltage and the eighth voltage during the first address period or the second address period subsequent to the auxiliary reset period is greater than a difference between the seventh voltage and the eighth voltage during the first address period or the second address period subsequent to the main reset period.

4. The driving method of claim 3, wherein the first reset period is the auxiliary reset period and the second reset period is the main reset period.

5. The driving method of claim 4,
wherein during the second address period a ninth voltage is applied to the first electrode of the turn-on discharge cell of the first group discharge cells, and
wherein the seventh voltage applied during the first address period is higher than the ninth voltage applied during the second address period.

6. The driving method of claim 4,
wherein during the first address period a ninth voltage is applied to the first electrode of the turn-on discharge cell of the second group discharge cells, and
wherein the eighth voltage applied during the second address period is higher than the ninth voltage applied during the second address period.

7. The driving method of claim 2, further comprising
applying a ninth voltage to the third electrode during a last portion of the first address period or a last portion of the second address period subsequent to the auxiliary reset period; and
gradually decreasing the voltage at the second electrode from a tenth voltage to an eleventh voltage during the last portion of the first address period or the last portion of the second address period subsequent to the auxiliary reset period,
wherein a difference between the ninth voltage and the eleventh voltage is greater than a difference between voltages applied to the second electrode and the third electrode when the second voltage is applied to the second electrode during the auxiliary reset period.

8. The driving method of claim 2, further comprising, during a subfield of the second group:
initializing the second group discharge cells during a third reset period;
selecting a turn-on discharge cell among the second group discharge cells during a third address period;
initializing the first group discharge cells during a fourth reset period;
selecting a turn-on discharge cell among the first group discharge cells during a fourth address period; and
sustain-discharging selected turn-on discharge cells during a sustain period,
wherein a voltage difference between the first electrode and the second electrode of a turn-on discharge cell selected during the third address period is different from a voltage difference between the first electrode and the second electrode of a turn-on discharge cell selected during the fourth address period.

9. The driving method of claim 8, wherein one of the third reset period and the fourth reset periods is the auxiliary reset period and the other of the third reset period and the fourth reset periods is the main reset period.

10. The driving method of claim 9, wherein the third reset period is the auxiliary reset period and the fourth reset period is the main reset period.

11. The driving method of claim 8, wherein
either the first subfield group consists of odd-numbered subfield and the second sub-field group consists of even-numbered subfields,
or the first subfield group consists of even-numbered subfield and the second sub-field group consists of odd-numbered subfields.

12. The driving method of claim 11, wherein
either the first group of the first electrodes consists of odd-numbered first electrodes and the second group of the first electrodes consists of even-numbered first electrodes,
or the first group of the first electrodes consists of even-numbered first electrodes and the second group of the first electrodes consists of odd-numbered first electrodes

13. A plasma display device comprising:
a plasma display panel having a plurality of first electrodes, a plurality of second electrodes, and a plurality of third electrodes crossing over the first electrodes and the second electrodes;
a controller driving the plurality of first electrodes as a plurality of groups including a first group of the first electrodes and a second group of the first electrodes, the controller driving the plurality of first electrodes during a plurality of subfields including a first subfield group and a second subfield group; and
a driving circuit initializing first group discharge cells corresponding to the first group of the first electrodes during a first reset period, address discharging the first group discharge cells during a first address period, initializing second group discharge cells during a second reset period, and address discharging the second group discharge cells corresponding to the second group of the first electrodes during a second address period, the first reset period, the first address period, the second reset period and the second address period occurring during a subfield of the first subfield group,
wherein the driving circuit applies voltages to the first electrodes and the second electrodes of the first group discharge cells during the first address period and the second address period, and
wherein during the first address period, a voltage difference between the first electrodes and the second electrodes of the first group discharge cells is different from a voltage difference between the first electrodes and the second electrodes of the second group discharge cells.

14. The plasma display device of claim 13, wherein either the first reset period or the second reset period is an auxiliary reset period for initializing a discharge cell having undergone a sustain discharge during a previous subfield, whilst the other is a main reset period for initializing discharge cells for the group in which the auxiliary reset has not been performed.

15. The plasma display device of claim 14,
wherein the driving circuit applies a second voltage to the second electrodes of the first group discharge cells while the first electrodes are maintained at a first voltage during the first address period and the second address period, and
wherein a voltage difference between the first electrodes and the second electrodes during the first address period or the second address period subsequent to the auxiliary reset period is greater than a voltage difference between the first electrodes and the second electrodes during the first address period or the second address period subsequent to the main reset period.

16. The plasma display device of claim 15, wherein the first reset period is the auxiliary reset period, and the second reset period is the main reset period.

17. The plasma display device of claim 14:
wherein the driving circuit in a subfield of the second subfield group, initializes the second group discharge cells during a third reset period, address discharges the second group discharge cells during a third address period, initializes the first group discharge cells during a fourth reset period, and address discharges the first group discharge cells during a fourth address period;
wherein, during the third address period and the fourth address period, the driving circuit applies voltages to the first electrodes and the second electrodes of the first group discharge cells and the second group discharge cells, and
wherein during the third address period, a voltage difference between the first electrodes and the second electrodes of the first group discharge cells is different from a voltage difference between the first electrodes and the second electrodes of the second group discharge cells.

18. The plasma display device of claim 17, wherein either the third reset period or the fourth reset period is the auxiliary reset period, and the other is the main reset period.

19. The plasma display device of claim 13, wherein during the second address period, the voltage difference between the first electrodes and the second electrodes of the first group discharge cells is different from the voltage difference between the first electrodes and the second electrodes of the second group discharge cells.

20. The plasma display device of claim 18, wherein during the fourth address period, the voltage difference between the first electrodes and the second electrodes of the first group discharge cells is different from the voltage difference between the first electrodes and the second electrodes of the second group discharge cells.
